(19) United States
(12) Patent Application Publication
(10) Pub. No.: US 2024/0258002 A1
(43) Pub. Date: Aug. 1, 2024

(54) CORE AND COIL COMPONENT

(71) Applicant: Murata Manufacturing Co., Ltd., Kyoto-fu (JP)

(72) Inventor: Yukihiro TANAKA, Nagaokakyo-shi (JP)

(73) Assignee: Murata Manufacturing Co., Ltd., Kyoto-fu (JP)

(21) Appl. No.: 18/419,714

(22) Filed: Jan. 23, 2024

(30) Foreign Application Priority Data
Jan. 30, 2023 (JP) 2023-012162

(51) Int. Cl. H01F 3/00; H01F 5/04

(52) U.S. Cl. CPC H01F 3/00; H01F 5/04

(57) ABSTRACT

A core includes a winding core, a first flange at a first end portion of the winding core, and a second flange at a second end portion of the winding core. The winding core has first and second surfaces on opposite sides, and first and second side surfaces intersecting the first and second surfaces and on opposite sides. The first flange has first and second surfaces on opposite sides, first and second side surfaces intersecting the first and second surfaces and located on opposite sides, an inner-side end surface connected to the first end portion of the winding core, and an outer-side end surface on an opposite side from the winding core. The inner-side end surface of the first flange has a first inclined surface between the first surface of the winding core and the first surface of the first flange.

### CROSS-REFERENCE TO RELATED APPLICATION

This application claims benefit of priority to Japanese Patent Application No. 2023-012162, filed Jan. 30, 2023, the entire content of which is incorporated herein by reference.

### BACKGROUND

### Technical Field

The present disclosure relates to a core and a coil component.

### Background Art

Conventionally, as a coil component, there has been the coil component described in Japanese Unexamined Patent Application Publication No. 2017-163026. The coil component includes a core and a coil. The core includes a winding core, a first flange, and a second flange. The winding core has a first surface and a second surface located on opposite sides, and a first end portion and a second end portion intersecting the first surface and the second surface and located on opposite sides. The first flange has a first surface, a second surface, and an inner-side end surface, on the winding core side, intersecting the first surface and the second surface. The inner-side end surface of the first flange is connected to the first end portion of the winding core. The second flange has a first surface, a second surface, and an inner-side end surface, on the winding core side, intersecting the first surface and the second surface. The inner-side end surface of the second flange is connected to the second end portion of the winding core.

### SUMMARY

When the conventional coil component is mounted on a mount substrate, the coil component is mounted on the mount substrate such that the first surfaces of the first and the second flanges face the mount substrate. At this time, there is a problem in which the first surfaces of the flanges receive a force from the substrate, and connecting portions between the inner-side end surfaces of the flanges and end portion of the winding core are damaged.

Therefore, the present disclosure provides a core and a coil component having improved strength.

An aspect of the present disclosure provides a core including a winding core, a first flange provided at a first end portion of the winding core, and a second flange provided at a second end portion of the winding core. The winding core has a first surface and a second surface located on opposite sides, and a first side surface and a second side surface intersecting the first surface and the second surface and located on opposite sides. The first flange has a first surface and a second surface located on opposite sides, a first side surface and a second side surface intersecting the first surface and the second surface and located on opposite sides, an inner-side end surface connected to the first end portion of the winding core, and an outer-side end surface located on an opposite side from the winding core. The inner-side end surface of the first flange has a first inclined surface located between the first surface of the winding core and the first surface of the first flange, and a second inclined surface located between the first side surface of the winding core and the first side surface of the first flange. A position of a first boundary where the first inclined surface intersects the first surface of the winding core is separated from a position of a second boundary where the second inclined surface intersects the first side surface of the winding core in a direction of an axis of the winding core.

As described above, since the position of the first boundary is separated from the position of the second boundary in the direction of the axis, the intersection point of the position of the first boundary and the position of the second boundary, which has conventionally existed, does not exist, and stress that has concentrated on the intersection point can be dispersed. As a result of the stress dispersion, the strength of the core can be improved. Note that an “axis of the winding core” is an axis passing through the center between the first surface and the second surface of the winding core, and the center between the first side surface and the second side surface of the winding core. A “direction of the axis of the winding core” is a direction intersecting the first end portion and the second end portion of the winding core.

According to the present disclosure, a core and a coil component having improved strength can be provided.

### BRIEF DESCRIPTION OF THE DRAWINGS

FIG. 1 is a perspective view of a core according to a first embodiment;

FIG. 2 is a sectional view taken along II-II of the core in FIG. 1;

FIG. 3 is a sectional view taken along III-III of the core in FIG. 1;

FIG. 4A is a partially enlarged view of an XY sectional view illustrating a first modification of the core according to the first embodiment;

FIG. 4B is a partially enlarged view of an XY sectional view illustrating a second modification of the core according to the first embodiment;

FIG. 5 is a partially enlarged view of an XY sectional view of a core according to a second embodiment;

FIG. 6 is a partially enlarged view of an XZ sectional view of the core according to the second embodiment;

FIG. 7 is a simulation graph illustrating a distance of a position of a second boundary and maximum stress;

FIG. 8 is an XZ sectional view of a core according to a third embodiment;

FIG. 9 is an XZ sectional view of a core according to a fourth embodiment;

FIG. 10 is a perspective view of a core according to a fifth embodiment;

FIG. 11 is a perspective view of a core according to a sixth embodiment; and

FIG. 12 is a side view of a coil component according to a seventh embodiment viewed from a first side surface side of a winding core.

### DETAILED DESCRIPTION

Hereinafter, a core and a coil component according to an aspect of the present disclosure will be described in detail by illustrated embodiments. Note that the drawings include partially schematic views and do not necessarily reflect actual dimensions or ratios.

### First Embodiment

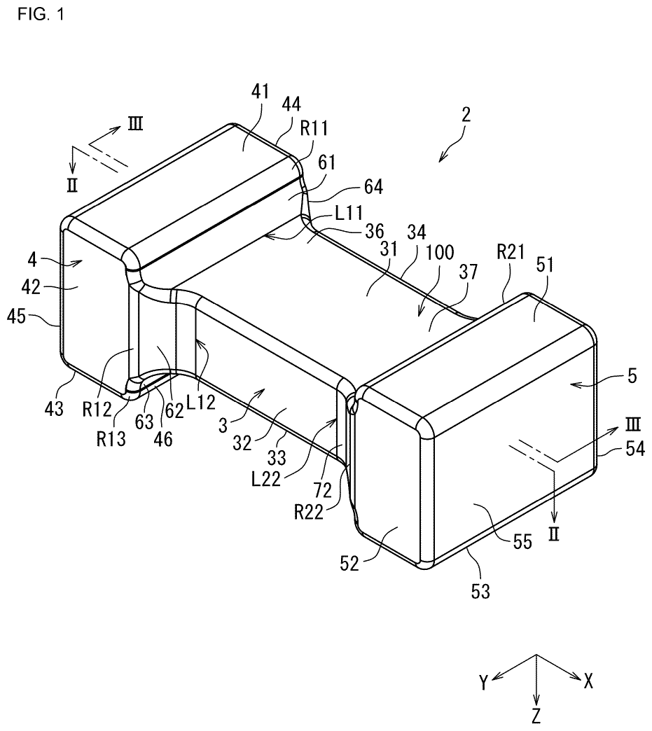

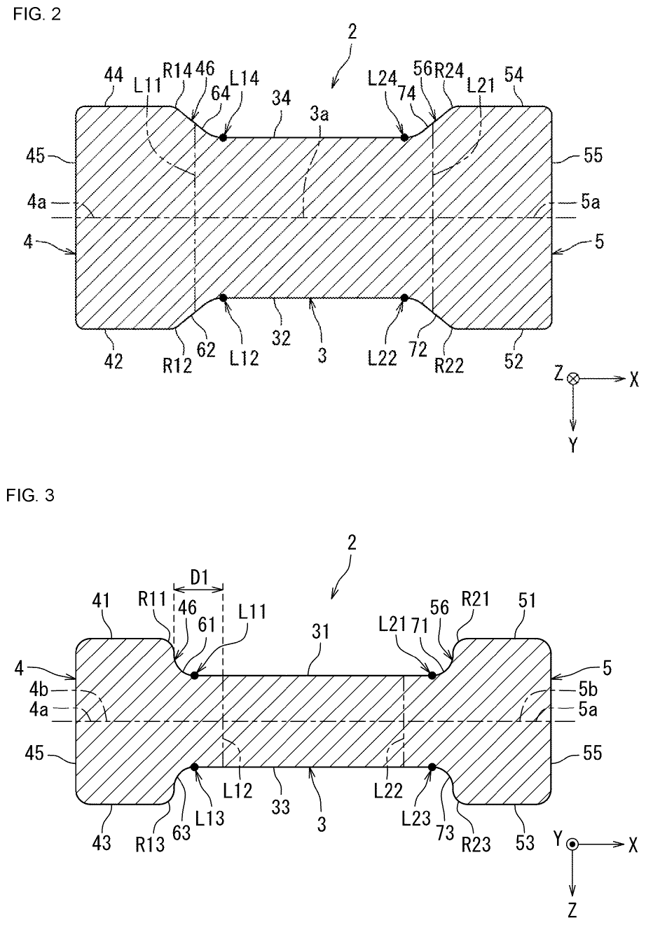

FIG. 1 is a perspective view illustrating a core 2 according to a first embodiment of the present disclosure. FIG. 2 is a sectional view taken along II-II of FIG. 1. FIG. 3 is a sectional view taken along III-III of FIG. 1.

As illustrated in FIGS. 1, 2, and 3, the core 2 includes a winding core 3, a first flange 4 provided at a first end portion 47 of the winding core 3, and a second flange 5 provided at a second end portion 57 of the winding core 3. The core 2 is made of, for example, a magnetic body such as ferrite, a resin containing a magnetic body or metal powder, and a non-magnetic body such as alumina.

The winding core 3 has a top surface (also referred to as a winding core-side top surface) 33 and a bottom surface (also referred to as a winding core-side bottom surface) 31 located on opposite sides, a first side surface (also referred to as a winding core-side first side surface) 32 and a second side surface (also referred to as a winding core-side second side surface) 34 intersecting the top surface 33 and the bottom surface 31 and located on opposite sides, and a first end portion (also referred to as a winding core-side first end portion) and a second end portion (also referred to as a winding core-side second end portion) intersecting the top surface 33 and the bottom surface 31 and located on opposite sides. The bottom surface 31, the first side surface 32, the top surface 33, and the second side surface 34 are flat surfaces. Note that in the winding core 3, the “top surface” is an example of a “second surface” described in the claims, and the “bottom surface” is an example of a “first surface” described in the claims. The same applies to the following embodiments. The winding core 3 has an axis 3a extending in a direction intersecting the first end portion and the second end portion. The axis 3a is an axis passing through the center between the bottom surface 31 and the top surface 33 of the winding core 3 and the center between the first side surface 32 and the second side surface 34 of the winding core 3. That is, the bottom surface 31, the first side surface 32, the top surface 33, and the second side surface 34 are parallel to the axis 3a. The outer surface of the winding core 3 includes the bottom surface 31, the first side surface 32, the top surface 33, and the second side surface 34 that are parallel to the axis 3a.

Note that as illustrated in the drawings, in the following description, for the sake of convenience, a Z-direction is a height direction of the winding core 3 and a direction from the bottom surface 31 toward the top surface 33. In addition, a Y-direction is a width direction of the winding core 3 and a direction from the second side surface 34 toward the first side surface 32. In addition, an X-direction is a length direction of the winding core 3 and a direction from the first end portion toward the second end portion. The X-direction, the Y-direction, and the Z-direction are directions orthogonal to each other, and constitute a right-handed system when arranged in the order of X, Y, and Z.

A curved surface exists in each of a space between the bottom surface 31 and the first side surface 32 of the winding core 3, a space between the bottom surface 31 and the second side surface 34 of the winding core 3, a space between the top surface 33 and the first side surface 32 of the winding core 3, and a space between the top surface 33 and the second side surface 34 of the winding core 3. That is, the bottom surface 31, the first side surface 32, the top surface 33, and the second side surface 34 of the winding core 3 are connected to the adjacent surfaces with curved surfaces interposed therebetween. Note that the bottom surface 31, the first side surface 32, the top surface 33, and the second side surface 34 may be directly connected without curved surfaces interposed therebetween.

The first flange 4 has a bottom surface (also referred to as a flange-side bottom surface) 41 and a top surface (also referred to as a flange-side top surface) 43 located on opposite sides, a first side surface (also referred to as a flange-side first side surface) 42 and a second side surface (also referred to as a flange-side second side surface) 44 intersecting the bottom surface 41 and the top surface 43 and located on opposite sides, an inner-side end surface (also referred to as a flange-side inner-side end surface) 46 connected to the first end portion of the winding core 3, and an outer-side end surface (also referred to as a flange-side outer-side end surface) 45 located on an opposite side from the winding core 3. The bottom surface 41 is provided on the same side as the bottom surface 31 of the winding core 3. The first side surface 42 is provided on the same side as the first side surface 32 of the winding core 3. The top surface 43 is provided on the same side as the top surface 33 of the winding core 3. The second side surface 44 is provided on the same side as the second side surface 34 of the winding core 3. Note that in the first flange 4, the “top surface” is an example of a “second surface” described in the claims, and the “bottom surface” is an example of a “first surface” described in the claims. The same applies to the following embodiments. Note that the first flange 4 has a central line 4b between the top surface 43 and the bottom surface 41 when viewed from the first side surface 42. The central line 4b is on the line extended from the axis 3a when viewed from the first side surface 42. An axis 4a of the first flange 4 is on the same line as the axis 3a of the winding core 3. When viewed form the first side surface 42, the axis 4a coincides with the central line 4b.

The bottom surface 41, the first side surface 42, the top surface 43, the second side surface 44, the outer-side end surface 45, and the inner-side end surface 46 are connected to the adjacent surfaces. The bottom surface 41 has a flat surface, a curved surface connected to the first side surface 42, a curved surface connected to the second side surface 44, a curved surface connected to the outer-side end surface 45, and a first curved surface R11 connected to the inner-side end surface 46. The first side surface 42 has a flat surface, a curved surface connected to the outer-side end surface 45, and a second curved surface R12 connected to the inner-side end surface 46. The top surface 43 has a flat surface, a curved surface connected to the first side surface 42, a curved surface connected to the second side surface 44, a curved surface connected to the outer-side end surface 45, and a third curved surface R13 connected to the inner-side end surface 46. The second side surface 44 has a flat surface, a curved surface connected to the outer-side end surface 45, and a fourth curved surface R14 connected to the inner-side end surface 46. Note that the bottom surface 41, the first side surface 42, the top surface 43, and the second side surface 44 may have only flat surfaces without having curved surfaces.

The inner-side end surface 46 has a region on the bottom surface 41 side, a region on the first side surface 42 side, a region on the top surface 43 side, and a region on the second side surface 44 side. The inner-side end surface 46 is connected to the outer surface of the winding core 3. The inner-side end surface 46 is not parallel to the axis 3a. That is, the boundary between the first flange 4 and the winding core 3 is the boundary between the inner-side end surface 46 that is not parallel to the axis 3a, and each of the bottom surface 31, the first side surface 32, the top surface 33, and the second side surface 34 that form the outer surface of the winding core 3 and are parallel to the axis 3a.

The region on the bottom surface 41 side has a first inclined surface 61. One end portion of the first inclined surface 61 is connected to the first curved surface R11, and the other end portion of the first inclined surface 61 is connected to the bottom surface 31. That is, the first curved surface R11, the first inclined surface 61, and the bottom surface 31 are connected in this order. The intersecting line of the first inclined surface 61 and the bottom surface 31 is the position of a first boundary L11. The first boundary L11 is a straight line, but may be a curved line. The first inclined surface 61 may have only a curved surface, may have only a flat surface, or may have a curved surface and a flat surface. The first inclined surface 61 may have one curved surface, may have a plurality of curved surfaces, may have one flat surface, or may have a plurality of flat surfaces. Preferably, the first inclined surface 61 has a curved surface, and the curved surface is connected to the bottom surface 31. When the bottom surface 31 is connected to a curved surface, stress can be dispersed. In addition, the first inclined surface 61 may have a flat surface and a curved surface, and in this case, the flat surface is connected to the first curved surface R11, and the curved surface is connected to the bottom surface 31.

The region on the first side surface 42 side has a second inclined surface 62. One end portion of the second inclined surface 62 is connected to the second curved surface R12, and the other end portion of the second inclined surface 62 is connected to the first side surface 32. That is, the second curved surface R12, the second inclined surface 62, and the first side surface 32 are connected in this order. The intersecting line of the second inclined surface 62 and the first side surface 32 is the position of a second boundary L12. The second boundary L12 is a straight line, but may be a curved line. The second inclined surface 62 may have only a curved surface, may have only a flat surface, or may have a curved surface and a flat surface. The second inclined surface 62 may have one curved surface, may have a plurality of curved surfaces, may have one flat surface, or may have a plurality of flat surfaces. Preferably, the second inclined surface 62 has a curved surface, and the curved surface is connected to the first side surface 32. When the first side surface 32 is connected to a curved surface, stress can be dispersed. In addition, the second inclined surface 62 may have a flat surface and a curved surface, and in this case, the flat surface is connected to the second curved surface R12, and the curved surface is connected to the first side surface 32.

The region on the top surface 43 side has a third inclined surface 63. One end portion of the third inclined surface 63 is connected to the third curved surface R13, and the other end portion of the third inclined surface 63 is connected to the top surface 33. That is, the third curved surface R13, the third inclined surface 63, and the top surface 33 are connected in this order. The intersecting line of the third inclined surface 63 and the top surface 33 is the position of a third boundary L13. The third boundary L13 is a straight line, but may be a curved line. The third inclined surface 63 may have only a curved surface, may have only a flat surface, or may have a curved surface and a flat surface. The third inclined surface 63 may have one curved surface, may have a plurality of curved surfaces, may have one flat surface, or may have a plurality of flat surfaces. Preferably, the third inclined surface 63 has a curved surface, and the curved surface is connected to the top surface 33. When the top surface 33 is connected to a curved surface, stress can be dispersed. In addition, the third inclined surface 63 may have a flat surface and a curved surface, and in this case, the flat surface is connected to the third curved surface R13, and the curved surface is connected to the top surface 33.

The region on the second side surface 44 side has a fourth inclined surface 64. One end portion of the fourth inclined surface 64 is connected to the fourth curved surface R14, and the other end portion of the fourth inclined surface 64 is connected to the second side surface 34. That is, the fourth curved surface R14, the fourth inclined surface 64, and the second side surface 34 are connected in this order. The intersecting line of the fourth inclined surface 64 and the second side surface 34 is the position of a fourth boundary L14. The fourth boundary L14 is a straight line, but may be a curved line. The fourth inclined surface 64 may have only a curved surface, may have only a flat surface, or may have a curved surface and a flat surface. The fourth inclined surface 64 may have one curved surface, may have a plurality of curved surfaces, may have one flat surface, or may have a plurality of flat surfaces. Preferably, the fourth inclined surface 64 has a curved surface, and the curved surface is connected to the second side surface 34. When the second side surface 34 is connected to a curved surface, stress can be dispersed. In addition, the fourth inclined surface 64 may have a flat surface and a curved surface, and in this case, the flat surface is connected to the fourth curved surface R14, and the curved surface is connected to the second side surface 34.

The position of the first boundary L11 and the position of the second boundary L12 are separated from each other in a direction of the axis 3a of the winding core 3. That is, the position of the first boundary L11 and the position of the second boundary L12 do not intersect. As in the conventional case, when the position of the first boundary L11 and the position of the second boundary L12 are not separated and intersect, in a case where the top surface 43 side is supported, if a load is applied in a direction from the bottom surface 31 toward the top surface 33, stress concentrates on the intersection point of the position of the first boundary L11 and the position of the second boundary L12. In particular, when a load is applied to the bottom surface 31 on the second flange 5 side in the direction from the bottom surface 31 toward the top surface 33, stress concentrates on the above-described intersection point. In addition, when the position of the first boundary L11 and the position of the second boundary L12 have an intersection point, in a case where a wire and a terminal electrode existing on the bottom surface 41 of the first flange 4 are thermocompression-bonded, if a load is applied to the top surface 33 from the bottom surface 31 on the first flange 4 side by a heater, stress concentrates on the above-described intersection point. On the other hand, when the above-described configuration is adopted, the intersection point of the position of the first boundary L11 and the position of the second boundary L12 does not exist. When a load is applied in the direction from the bottom surface 31 toward the top surface 33 of the winding core 3, the stress concentrating on the intersection point can be dispersed. In particular, when a load is applied to the bottom surface 31 on the second flange 5 side in the direction from the bottom surface 31 toward the top surface 33, the stress can be dispersed. In addition, when a wire and an outer electrode are thermocompression-bonded, even if a load is applied by a heater, the stress can be dispersed. As a result, the strength of the core 2 can be further improved.

Preferably, the position of the first boundary L11 and the position of the fourth boundary L14 are separated from each other in the direction of the axis 3a of the winding core 3. When viewed in a direction orthogonal to the second side surface 34 of the winding core 3, the position of the second boundary L12 and the position of the fourth boundary L14 overlap. When the above-described configuration is adopted, the intersection point of the position of the first boundary L11 and the position of the fourth boundary L14 does not exist. As a result, when a load is applied in a direction from the bottom surface 31 on the first flange 4 side toward the top surface 33, the stress can be dispersed. Note that the position of the first boundary L11 and the position of the fourth boundary L14 do not have to be separated. That is, the position of the first boundary L11 and the position of the fourth boundary L14 may have an intersection point.

Preferably, the position of the third boundary L13 and the position of the second boundary L12 are separated from each other in the direction of the axis 3a of the winding core 3. When the above-described configuration is adopted, the intersection point of the position of the third boundary L13 and the position of the second boundary L12 does not exist, and when a load is applied in a direction from the top surface 33 on the first flange 4 side toward the bottom surface 31, the stress can be dispersed.

Preferably, the position of the third boundary L13 and the position of the fourth boundary L14 are separated from each other in the direction of the axis 3a of the winding core 3. When viewed in a direction orthogonal to the bottom surface 31 of the winding core 3, the position of the first boundary L11 and the position of the third boundary L13 overlap. When the above-described configuration is adopted, the intersection point of the position of the third boundary L13 and the position of the fourth boundary L14 does not exist, and when a load is applied in the direction from the top surface 33 on the first flange 4 side toward the bottom surface 31, the stress can be dispersed.

Preferably, the position of the second boundary L12 is closer to the second flange 5 than is the position of the first boundary L11 in the direction of the axis 3a of the winding core 3. When the above-described configuration is adopted, the width of the first flange 4 along the position of the first boundary L11 when viewed from the bottom surface 31 of the winding core 3 can be increased, and the stress can be further dispersed. As a result, the strength of the core 2 can be improved. Note that when the position of the first boundary L11 is compared with the position of the second boundary L12, the second boundary L12 is the position of an end portion of the second boundary L12 on the first boundary L11 side. When the position of the first boundary L11 is compared with the position of the second boundary L12, the first boundary L11 is the position of an end portion of the first boundary L11 on the second boundary L12 side.

Preferably, the position of the second boundary L12 is closer to the second flange 5 than is the position of the third boundary L13 in the direction of the axis 3a of the winding core 3. When the above-described configuration is adopted, the width of the first flange 4 along the position of the third boundary L13 when viewed from the top surface 33 of the winding core 3 can be increased, and the stress can be further dispersed. As a result, the strength of the core 2 can be improved.

Preferably, the position of the fourth boundary L14 is closer to the second flange 5 than is the position of the first boundary L11 in the direction of the axis 3a of the winding core 3. When the above-described configuration is adopted, the width of the first flange 4 along the position of the first boundary L11 when viewed from the bottom surface 31 of the winding core 3 can be increased, and thus the stress can be further reduced. Accordingly, the strength of the core 2 can be improved.

Preferably, the position of the fourth boundary L14 is closer to the second flange 5 than is the position of the third boundary L13 in the direction of the axis 3a of the winding core 3. When the above-described configuration is adopted, the width of the first flange 4 along the position of the third boundary L13 when viewed from the bottom surface 31 of the winding core 3 can be increased, and thus the stress can be further reduced. Accordingly, the strength of the core 2 can be improved.

Preferably, the first inclined surface 61 has a recessed curved surface. Note that the first inclined surface 61 may have a flat surface, or may have a flat surface and a recessed curved surface.

Preferably, the second inclined surface 62 has a flat surface. When the above-described configuration is adopted, in a case where a wire is wound, the position of the wire on the first flange 4 side can be easily determined. The second inclined surface 62 may have a flat surface located on the second curved surface R12 side and a recessed curved surface located on the first side surface 32 side.

Preferably, the third inclined surface 63 has a recessed curved surface. Note that the third inclined surface 63 may have a flat surface, or may have a flat surface and a recessed curved surface.

Preferably, the fourth inclined surface 64 has a flat surface. When the above-described configuration is adopted, in a case where a wire is wound, the position of the wire on the first flange 4 side can be easily determined. The fourth inclined surface 64 may have a flat surface located on the fourth curved surface R14 side and a recessed curved surface located on the second side surface 34 side.

The second flange 5 has the same configuration as the first flange 4. The second flange 5 has a bottom surface (also referred to as a flange-side bottom surface) 51, a top surface (also referred to as a flange-side top surface) 53 located on opposite sides, a first side surface (also referred to as a flange-side first side surface) 52 and a second side surface (also referred to as a flange-side second side surface) 54 intersecting the bottom surface 51 and the top surface 53 and located on opposite sides, an inner-side end surface (also referred to as a flange-side inner-side end surface) 56 connected to the second end portion of the winding core 3, and an outer-side end surface (also referred to as a flange-side outer-side end surface) 55 located on an opposite side from the winding core 3. The bottom surface 51 is provided on the same side as the bottom surface 31 of the winding core 3. The first side surface 52 is provided on the same side as the first side surface 32 of the winding core 3. The top surface 53 is provided on the same side as the top surface 33 of the winding core 3. The second side surface 54 is provided on the same side as the second side surface 34 of the winding core 3. Note that in the second flange 5, the “top surface” is an example of a “second surface”, and the “bottom surface” is an example of a “first surface”. The same applies to the following embodiments. Note that the second flange 5 has a central line 5b between the top surface 53 and the bottom surface 51 when viewed from the second side surface 54. The central line 5b is on the line extended from the axis 3a when viewed from the second side surface 54. An axis 5a of the second flange 5 is on the same line as the axis 3a of the winding core 3. When viewed form the second side surface 54, the axis 5a coincides with the central line 5b.

The bottom surface 51, the first side surface 52, the top surface 53, the second side surface 54, the outer-side end surface 55, and the inner-side end surface 56 are connected to the adjacent surfaces. The bottom surface 51 has a flat surface, a curved surface connected to the first side surface 52, a curved surface connected to the second side surface 54, a curved surface connected to the outer-side end surface 55, and a first curved surface R21 connected to the inner-side end surface 56. The first side surface 52 has a flat surface, a curved surface connected to the outer-side end surface 55, and a second curved surface R22 connected to the inner-side end surface 56. The top surface 53 has a flat surface, a curved surface connected to the first side surface 52, a curved surface connected to the second side surface 54, a curved surface connected to the outer-side end surface 55, and a third curved surface R23 connected to the inner-side end surface 56. The second side surface 54 has a flat surface, a curved surface connected to the outer-side end surface 55, and a fourth curved surface R24 connected to the inner-side end surface 56. Note that the bottom surface 51, the first side surface 52, the top surface 53, and the second side surface 54 may have only flat surfaces without having curved surfaces.

The inner-side end surface 56 has a region on the bottom surface 51 side, a region on the first side surface 52 side, a region on the top surface 53 side, and a region on the second side surface 54 side. The inner-side end surface 56 is connected to the outer surface of the winding core 3. The inner-side end surface 56 is not parallel to the axis 3a. That is, the boundary between the second flange 5 and the winding core 3 is the boundary between the inner-side end surface 56 that is not parallel to the axis 3a, and each of the bottom surface 31, the first side surface 32, the top surface 33, and the second side surface 34 that form the outer surface of the winding core 3 and are parallel to the axis 3a.

The region on the bottom surface 51 side has a first inclined surface 71. One end portion of the first inclined surface 71 is connected to the first curved surface R21, and the other end portion of the first inclined surface 71 is connected to the bottom surface 31. That is, the first curved surface R21, the first inclined surface 71, and the bottom surface 31 are connected in this order. The intersecting line of the first inclined surface 71 and the bottom surface 31 is the position of a first boundary L21. The first boundary L21 is a straight line, but may be a curved line.

The region on the first side surface 52 side has a second inclined surface 72. One end portion of the second inclined surface 72 is connected to the second curved surface R22, and the other end portion of the second inclined surface 72 is connected to the first side surface 32. That is, the second curved surface R22, the second inclined surface 72, and the first side surface 32 are connected in this order. The intersecting line of the second inclined surface 72 and the first side surface 32 is the position of a second boundary L22. The second boundary L22 is a straight line, but may be a curved line.

The region on the top surface 53 side has a third inclined surface 73. One end portion of the third inclined surface 73 is connected to the third curved surface R23, and the other end portion of the third inclined surface 73 is connected to the top surface 33. That is, the third curved surface R23, the third inclined surface 73, and the top surface 33 are connected in this order. The intersecting line of the third inclined surface 73 and the top surface 33 is the position of a third boundary L23. The third boundary L23 is a straight line, but may be a curved line.

The region on the second side surface 54 side has a fourth inclined surface 74. One end portion of the fourth inclined surface 74 is connected to the fourth curved surface R24, and the other end portion of the fourth inclined surface 74 is connected to the second side surface 34. That is, the fourth curved surface R24, the fourth inclined surface 74, and the second side surface 34 are connected in this order. The intersecting line of the fourth inclined surface 74 and the second side surface 34 is the position of a fourth boundary L24. The fourth boundary L24 is a straight line, but may be a curved line.

The positions of the first to the fourth boundaries L21 to L24, and the first to the fourth inclined surfaces 71 to 74 of the second flange 5 have the same configurations as the positions of the first to the fourth boundaries L11 to L14, and the first to the fourth inclined surfaces 61 to 64 of the first flange 4, and have the same effects.

Note that the core 2 may be coated with a resin such as an epoxy resin. For example, a resin is applied to the core 2 by dipping the top surface 33 side, the top surface 43 side, and the top surface 53 side in a resin bath, and then the core 2 is pressed against a sheet so as to make the top surfaces 33, 43, and 53 flat. Note that the core 2 may be in a state in which a magnetic body and the like are exposed without being coated with a resin.

### First Modification

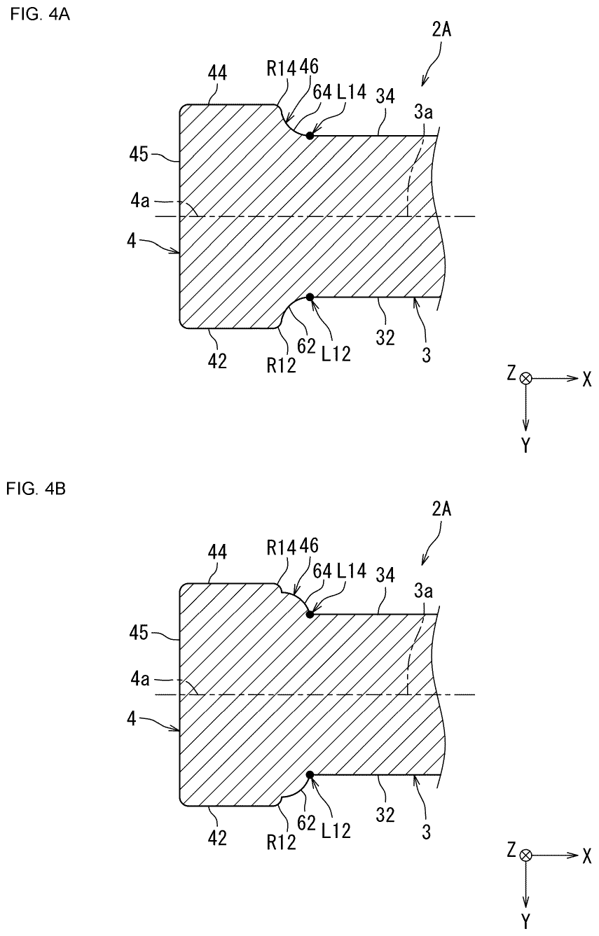

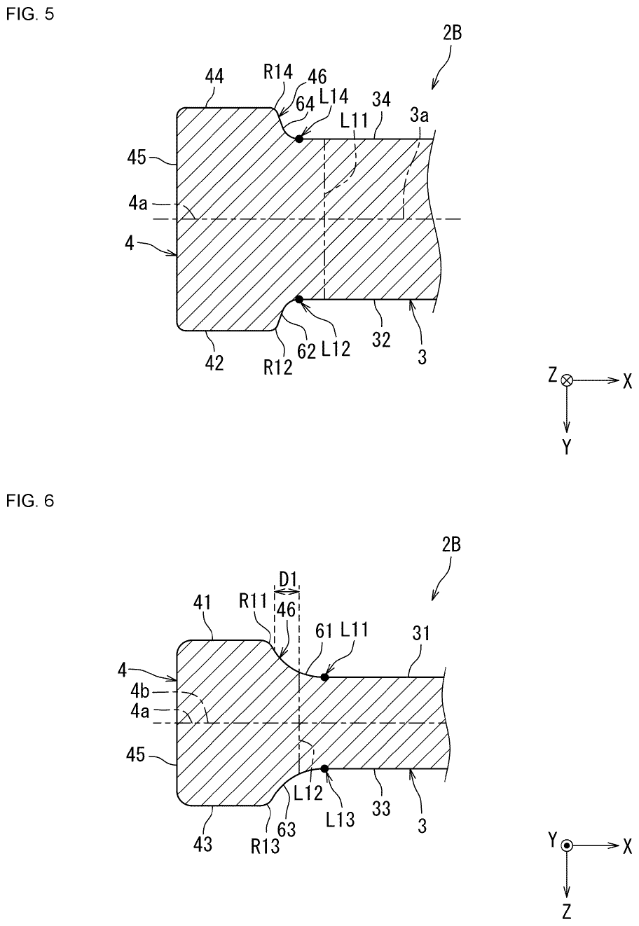

FIG. 4A is an XY sectional view of a core 2A according to a first modification of the first embodiment of the present disclosure, and is an enlarged view illustrating the first flange 4 and a part of the winding core 3. In the first modification, the shape of the second inclined surface 62 is different from the first embodiment. The different configuration will be described below. Other configurations are the same as the first embodiment, and the description thereof will be omitted.

As illustrated in FIG. 4A, the second inclined surface 62 has a recessed curved surface. When the above-described configuration is adopted, a winding space for a wire is increased. Note that the fourth inclined surface 64 may have a recessed curved surface in the same manner as the second inclined surface 62.

### Second Modification

FIG. 4B is an XY sectional view of the core 2A according to a second modification of the first embodiment of the present disclosure, and is an enlarged view illustrating the first flange 4 and a part of the winding core 3. In the second modification, the shape of the second inclined surface 62 is different from the first embodiment. The different configuration will be described below. Other configurations are the same as the first embodiment, and the description thereof will be omitted.

As illustrated in FIG. 4B, the second inclined surface 62 has a projecting curved surface. When the above-described configuration is adopted, the width of the first flange 4 in a direction orthogonal to the axis 3a when viewed from the bottom surface, and on a straight line intersecting the second inclined surface 62 and the fourth inclined surface 64, is increased, the stress is dispersed, and the strength can be improved. Note that the fourth inclined surface 64 may have a projecting curved surface in the same manner as the second inclined surface 62.

Note that the second inclined surface 62 may have at least one of a flat surface, a recessed curved surface, and a projecting curved surface. At this time, the fourth inclined surface 64 may have the same configuration as the second inclined surface 62.

Note that the configuration of the winding core 3 on the top surface side may be the same as the configuration of the winding core 3 on the bottom surface side according to the first embodiment. At this time, the effects obtained on the top surface side of the winding core 3 are the same as the effects obtained on the bottom surface side of the winding core 3 according to the first embodiment. That is, in the winding core 3, the “top surface” corresponds to a “first surface” of the claims, and the “bottom surface” corresponds to a “second surface” of the claims. The configuration of the first flange 4 on the top surface side may be the same as the configuration of the first flange 4 on the bottom surface side according to the first embodiment. At this time, the effects obtained on the top surface side of the first flange 4 are the same as the effects obtained on the bottom surface side of the first flange 4 according to the first embodiment. That is, in the first flange 4, the “top surface” corresponds to a “first surface” of the claims, and the “bottom surface” corresponds to a “second surface” of the claims. The configuration of the second flange 5 on the top surface side may be the same as the configuration of the second flange 5 on the bottom surface side according to the first embodiment. At this time, the effects obtained on the top surface side of the second flange 5 are the same as the effects obtained on the bottom surface side of the second flange 5 according to the first embodiment. That is, in the second flange 5, the “top surface” corresponds to a “first surface” of the claims, and the “bottom surface” corresponds to a “second surface” of the claims.

### Second Embodiment

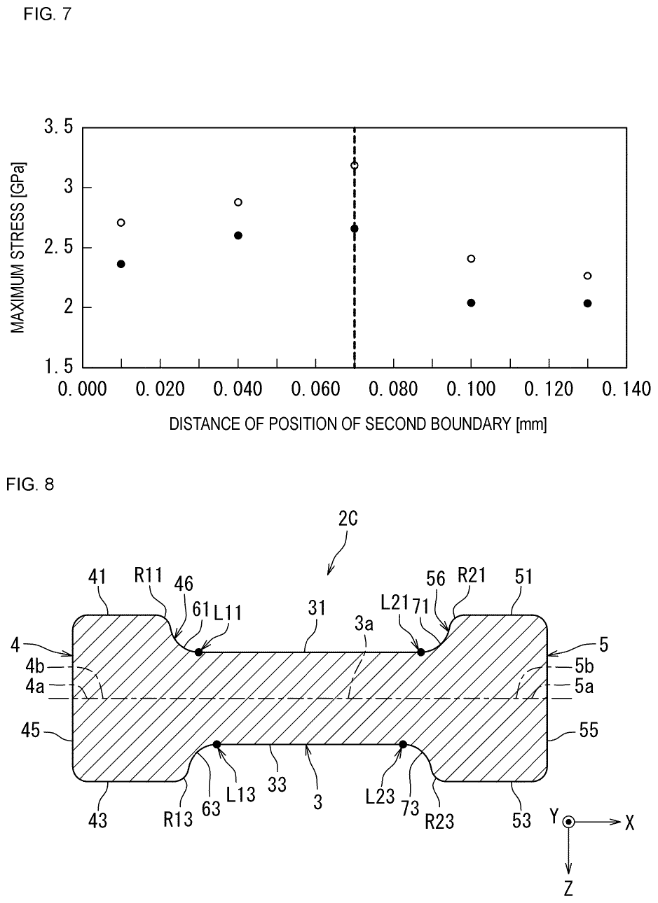

FIG. 5 is a partially enlarged view of an XY sectional view of a core 2B according to a second embodiment of the present disclosure. FIG. 6 is a partially enlarged view of an XZ sectional view of the core 2B. The second embodiment is different from the first embodiment in the positions of the first to the fourth boundaries L11 to L14. The different configurations will be described below. Other configurations are the same as the first embodiment, and the description thereof will be omitted.

The position of the first boundary L11 is closer to the second flange 5 than is the position of the second boundary L12 in the direction of the axis 3a of the winding core 3. When the above-described configuration is adopted, in the same manner as the first embodiment, the stress can be dispersed. When a load is applied in a direction from the top surface 33 toward the bottom surface 31 of the winding core 3, the stress can be dispersed. As a result, the strength of the core 2B can be further improved. Moreover, since the region of the first side surface 32 of the winding core 3 can be increased toward the first flange 4 side, the winding space for a wire is increased.

Preferably, the position of the first boundary L11 is closer to the second flange 5 than is the position of the fourth boundary L14 in the direction of the axis 3a of the winding core 3. When the above-described configuration is adopted, in a case where a load is applied in the direction from the bottom surface 31 toward the top surface 33 of the winding core 3, the stress can be dispersed. As a result, the strength of the core 2B can be further improved. Moreover, since the region of the second side surface 34 of the winding core 3 can be increased toward the first flange 4 side, the winding space for a wire is increased.

Preferably, the position of the third boundary L13 is closer to the second flange 5 than is the position of the second boundary L12 in the direction of the axis 3a of the winding core 3. When the above-described configuration is adopted, the stress can be dispersed, and the strength of the core 2B can be further improved.

Preferably, the position of the third boundary L13 is closer to the second flange 5 than is the position of the fourth boundary L14 in the direction of the axis 3a of the winding core 3. When the above-described configuration is adopted, the stress can be dispersed, and the strength of the core 2B can be further improved.

In the second flange 5 as well, as described below, the same configuration as the first flange 4 is adopted, and the same effects can be obtained.

The position of the first boundary L21 is closer to the first flange 4 than is the position of the second boundary L22 in the direction of the axis 3a of the winding core 3.

Preferably, the position of the first boundary L21 is closer to the first flange 4 than is the position of the fourth boundary L24 in the direction of the axis 3a of the winding core 3.

Preferably, the position of the third boundary L23 is closer to the first flange 4 than is the position of the second boundary L22 in the direction of the axis 3a of the winding core 3.

Preferably, the position of the third boundary L23 is closer to the first flange 4 than is the position of the fourth boundary L24 in the direction of the axis 3a of the winding core 3.

### Example

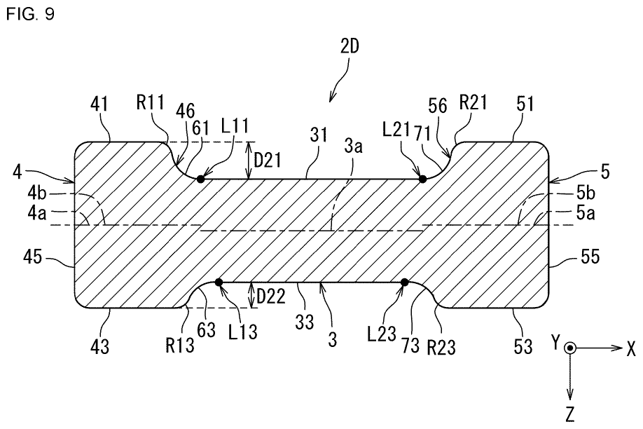

FIG. 7 is a simulation graph illustrating a distance D1 (mm) of a position of a second boundary and maximum stress (GPa). The X-axis indicates the distance of the position of the second boundary L12, and the Y-axis indicates the maximum stress (GPa) received by the core 2 or the core 2B when a load is applied. Note that the distance of the position of the second boundary is the width from the end portion of the bottom surface 41 and the first curved surface R11 on the bottom surface side to the position of the second boundary L12 in the direction of the axis 3a in FIGS. 3 and 6. The black dots in FIG. 7 represent the maximum stress generated in the core 2 or the core 2B when a load is vertically applied from above the bottom surface 31 on the second flange 5 side of the winding core 3. The white dots in FIG. 7 represent the maximum stress generated in the core 2 or the core 2B when a load is applied in a direction including the X direction and a direction including the Z direction. Note that FIG. 7 is a simulation graph using Femtet manufactured by Murata Software Co., Ltd. An L value (a length in the X direction) of the core 2 or 2B used in the simulation is 2.6 mm, a W value (a length in the Y direction) is 2.5 mm, and a T value (a length in the Z direction) is 1.8 mm. In FIG. 7, when the distance D1 of the position of the second boundary is 0.070 mm, the position of the second boundary L12 and the position of the first boundary L11 are at the same position in the direction of the axis 3a. That is, the position of the second boundary L12 and the position of the first boundary L11 have an intersection point. When the distance D1 of the position of the second boundary is 0.070 mm, the maximum stress generated in the core became the largest. On the other hand, when the position of the second boundary L12 is closer to the second flange 5 than is the position of the first boundary L11 in the direction of the axis 3a of the winding core 3, that is, when the distance D1 is increased, the maximum stress generated in the core 2 is decreased. As the distance D1 is increased, the maximum stress generated in core 2 is decreased. In addition, when the position of the first boundary L11 is closer to the second flange 5 than is the position of the second boundary L12 in the direction of the axis 3a of the winding core 3, that is, when the distance D1 is decreased, the maximum stress generated in the core 2B is decreased. As the distance D1 is decreased, the maximum stress generated in the core 2B is decreased.

### Third Embodiment

FIG. 8 is an XZ sectional view illustrating a core 2C according to a third embodiment of the present disclosure. The third embodiment is different from the first embodiment in the positional relationship between the position of the first boundary L11 and the position of the third boundary L13. The different configuration will be described below. Other configurations are the same as the first embodiment, and the description thereof will be omitted.

The position of the third boundary L13 of the first flange 4 is closer to the second flange 5 than is the position of the first boundary L11 of the first flange 4 in the direction of the axis 3a of the winding core 3. When the above-described configuration is adopted, in a case where a load is applied in the direction from the bottom surface 31 on the second flange 5 side toward the top surface 33, the stress that is generated can be dispersed. As a result, the stress is less likely to concentrate, and the strength of the core 2C can be improved. In addition, on the section of FIG. 8, the width of the top surface 43 of the first flange 4 in the direction of the axis 3a is increased, and damage such as a crack is less likely to occur. Moreover, when the above-described configuration is adopted, the width of the bottom surface 31 becomes smaller than the width of the top surface 33, and the top and the bottom of the core 2C can be easily identified. For example, when the core 2C is inserted into a pallet, insertion can be performed while the top and the bottom are identified.

Preferably, the position of the third boundary L23 of the second flange 5 is closer to the first flange 4 than is the position of the first boundary L21 of the second flange 5 in the direction of the axis 3a of the winding core 3. When the above-described configuration is adopted, in a case where a load is applied in the direction from the bottom surface 31 on the first flange 4 side toward the top surface 33, the stress that is generated can be dispersed in a direction of the top surface 53.

Note that the configuration of the winding core 3 on the bottom surface side may be the same as the configuration of the winding core 3 on the top surface side according to the third embodiment. At this time, the effects obtained on the bottom surface side of the winding core 3 are the same as the effects obtained on the top surface side of the winding core 3 according to the third embodiment. That is, in the winding core 3, the “bottom surface” corresponds to a “second surface” of the claims, and the “top surface” corresponds to a “first surface” of the claims. The configuration of the first flange 4 on the bottom surface side may be the same as the configuration of the first flange 4 on the top surface side according to the third embodiment. At this time, the effects obtained on the bottom surface side of the first flange 4 are the same as the effects obtained on the top surface side of the first flange 4 according to the third embodiment. That is, in the first flange 4, the “bottom surface” corresponds to a “second surface” of the claims, and the “top surface” corresponds to a “first surface” of the claims.

### Fourth Embodiment

FIG. 9 is an XZ sectional view illustrating a core 2D according to a fourth embodiment of the present disclosure. The fourth embodiment is different from the third embodiment in the positional relationship among the central line 4b of the first flange 4, the central line 5b of the second flange 5, and the axis 3a of the winding core 3. The different configuration will be described below. Other configurations are the same as the third embodiment, and the description thereof will be omitted.

When viewed from the first side surface 42, the axis 3a of the winding core 3 is closer to the top surface 43 of the first flange 4 than is the central line 4b of the first flange 4. That is, a distance D21 between the bottom surface 41 of the first flange 4 and the bottom surface 31 of the winding core 3 when viewed from the second side surface 34 side of the winding core 3 in the Z direction is longer than a distance D22 between the top surface 43 of the first flange 4 and the top surface 33 of the winding core 3 when viewed from the second side surface 34 side of the winding core 3 in the Z direction. When the above-described configuration is adopted, in a case where the coil component is mounted on a mount substrate, the distance between the mount substrate and the bottom surface 31 of the winding core 3 is increased. As a result, the distance between the top surface 43 of the first flange 4 and the top surface 33 of the winding core 3 can be decreased, and the height of the core 2D can be reduced.

In the second flange 5 as well, as described below, the same configuration as the first flange 4 is adopted, and the same effects can be obtained. When viewed from the first side surface 52, the axis 3a of the winding core 3 is closer to the top surface 53 of the second flange 5 than is the central line 5b of the second flange 5.

Note that the configuration of the first flange 4 on the bottom surface side may be the same as the configuration of the first flange 4 on the top surface side according to the fourth embodiment. At this time, the effects obtained on the bottom surface side of the first flange 4 are the same as the effects obtained on the top surface side of the first flange 4 according to the fourth embodiment. That is, in the first flange 4, the “bottom surface” corresponds to a “second surface” of the claims, and the “top surface” corresponds to a “first surface” of the claims.

### Fifth Embodiment

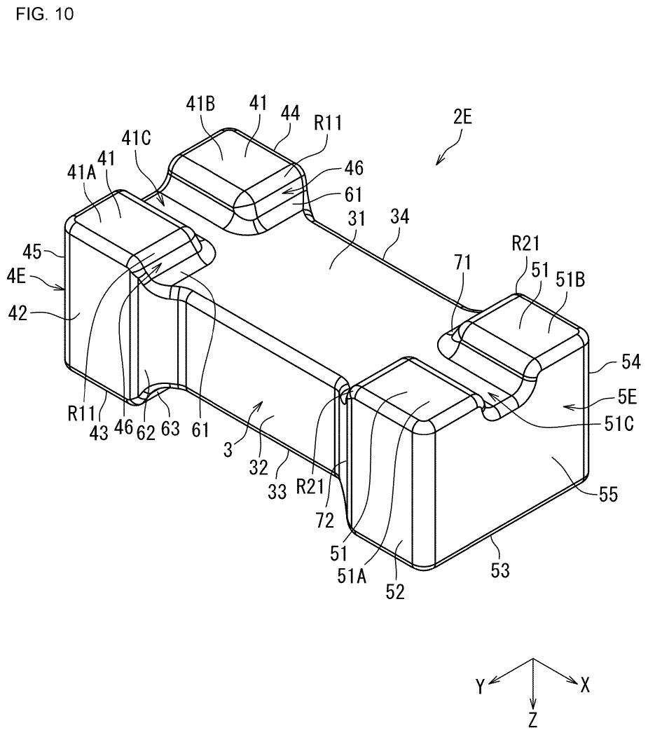

FIG. 10 is a perspective view illustrating a core 2E according to a fifth embodiment of the present disclosure. The fifth embodiment is different from the first embodiment in the structure of the bottom surface 41 of a first flange 4E and the structure of the bottom surface 51 of a second flange 5E. The different configurations will be described below. Other configurations are the same as the first embodiment, and the description thereof will be omitted.

The bottom surface 41 of the first flange 4E is divided into two, which are a first bottom surface 41A and a second bottom surface 41B. When the above-described configuration is adopted, the degree of freedom in designing the core 2E is increased, and the core 2E can be formed into various shapes. Note that in the fifth embodiment, the bottom surface 41 of the first flange 4E is divided into two, but may be divided into three or more.

The first bottom surface 41A is provided on the first side surface 42 side and is in contact with the outer-side end surface 45. The second bottom surface 41B is provided on the second side surface 44 side and is in contact with the outer-side end surface 45. A groove 41C is provided between the first bottom surface 41A and the second bottom surface 41B. The groove 41C has a bottom surface, a first side surface connecting the bottom surface to the first bottom surface 41A, and a second side surface connecting the bottom surface to the second bottom surface 41B. The first side surface has an inclined surface, one end portion of the inclined surface is connected to the bottom surface of the groove 41C, and the other end portion of the inclined surface is connected to the first bottom surface 41A. The second side surface has an inclined surface, one end portion of the inclined surface is connected to the bottom surface of the groove 41C, and the other end portion of the inclined surface is connected to the second bottom surface 41B. When the above-described configuration is adopted, an electrode provided on the first bottom surface 41A is separated from an electrode provided on the second bottom surface 41B, and electrical connection can be suppressed. Note that the above-described inclined surfaces may be flat surfaces, recessed curved surfaces, or projecting curved surfaces.

The bottom surface 51 of the second flange 5E has the same configuration of the bottom surface 41 of the first flange 4 as described below, and has the same effects. The bottom surface 51 of the second flange 5E is divided into two, which are a first bottom surface 51A and a second bottom surface 51B. Note that in the fifth embodiment, the bottom surface 51 of the second flange 5E is divided into two, but may be divided into three or more. The first bottom surface 51A is provided on the first side surface 52 side and is in contact with the outer-side end surface 55. The second bottom surface 51B is provided on the second side surface 54 side and is in contact with the outer-side end surface 55. A groove 51C is provided between the first bottom surface 51A and the second bottom surface 51B. The groove 51C has a bottom surface, a first side surface connecting the bottom surface to the first bottom surface 51A, and a second side surface connecting the bottom surface to the second bottom surface 51B. The first side surface has an inclined surface, one end portion of the inclined surface is connected to the bottom surface of the groove 51C, and the other end portion of the inclined surface is connected to the first bottom surface 51A. The second side surface has an inclined surface, one end portion of the inclined surface is connected to the bottom surface of the groove 51C, and the other end portion of the inclined surface is connected to the second bottom surface 51B.

### Sixth Embodiment

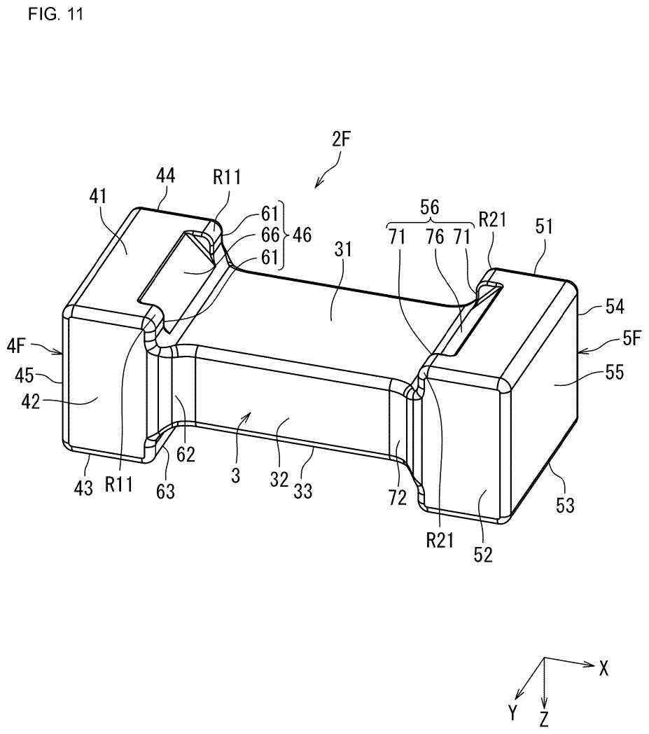

FIG. 11 is a perspective view illustrating a core 2F according to a sixth embodiment of the present disclosure. The sixth embodiment is different from the first embodiment in the structure of the region on the bottom surface 41 side of the inner-side end surface 46 and the structure of the region on the bottom surface 51 side of the inner-side end surface 56. The different configurations will be described below. Other configurations are the same as the first embodiment, and the description thereof will be omitted.

The region on the bottom surface 41 side of the inner-side end surface 46 of a first flange 4F further has a flat guide surface 66 extending in a direction from the bottom surface 41 of the first flange 4F toward the bottom surface 31 of the winding core 3. When the above-described configuration is adopted, in a case where a wire is wound around the core 2F, the wire is brought into contact with the guide surface 66 so that the position of the wire can be stabilized. Specifically, the end portion, on the first flange 4F side, of the wire wound around the core 2F is connected to a first terminal electrode provided on the bottom surface 41 of the first flange 4 along the guide surface 66.

Preferably, the region on the bottom surface 41 side of the inner-side end surface 46 of the first flange 4F has the flat guide surface 66 and a recessed curved surface. The flat guide surface 66 is connected to the bottom surface 41. The recessed curved surface is connected to the bottom surface 31 of the winding core 3. That is, the flat surface of the bottom surface 41, the curved surface included in the bottom surface 41, the guide surface 66, the above-described recessed curved surface, and the bottom surface 31 are connected in this order. Note that the region on the bottom surface 41 side of the inner-side end surface 46 may include only the flat guide surface 66.

Preferably, the region on the bottom surface 41 side of the inner-side end surface 46 further has a first inclined surface 61, together with and in addition to the guide surface 66. That is, the region on the bottom surface 41 side of the inner-side end surface 46 has a first inclined surface 61 on the first side surface 42 side, the guide surface 66, and a first inclined surface 61 on the second side surface 44 side. The connecting portion between the first curved surface R11 and the flat surface of the bottom surface 41 is closer to the second flange 5F than is the connecting portion between the guide surface 66 and the flat surface of the bottom surface 41. That is, the first curved surface R11 is located at a position higher than the guide surface 66. When the above-described configuration is adopted, the wire can be protected from an external force from the first side surface 42 or the second side surface 44 of the core 2F.

Preferably, when viewed in a direction perpendicular to the bottom surface 41, the intersecting line of the first inclined surface 61 on the first side surface 42 side and the bottom surface 31, the intersecting line of the guide surface 66 and the bottom surface 31, and the intersecting line of the first inclined surface 61 on the second side surface 44 side and the bottom surface 31 are located on the same straight line. That is, the position of the above-described three intersecting lines is the position of the first boundary L11.

A second flange 5F has the same configuration as the first flange 4F as described below, and has the same effects. The region on the bottom surface 51 side of the inner-side end surface 56 of the second flange 5F further has a flat guide surface 76 extending in a direction from the bottom surface 51 of the second flange 5F toward the bottom surface 31 of the winding core 3. Specifically, the end portion, on the second flange 5F side, of the wire wound around the core 2F is connected to a second terminal electrode provided on the bottom surface 51 of the second flange 5F along the guide surface 76. Preferably, the region on the bottom surface 51 side of the inner-side end surface 56 of the second flange 5F has the flat guide surface 76 and a recessed curved surface. The flat guide surface 76 is connected to the bottom surface 51. The recessed curved surface is connected to the bottom surface 31 of the winding core 3. That is, the flat surface of the bottom surface 51, the curved surface included in the bottom surface 51, the guide surface 76, the above-described recessed curved surface, and the bottom surface 31 are connected in this order. Preferably, the region on the bottom surface 51 side of the inner-side end surface 56 further has a first inclined surface 71, together with and in addition to the guide surface 76. That is, the region on the bottom surface 51 side of the inner-side end surface 56 has a first inclined surface 71 on the first side surface 52 side, the guide surface 76, and a first inclined surface 71 on the second side surface 54 side. The connecting portion between the first curved surface R21 and the flat surface of the bottom surface 51 is closer to the first flange 4F than is the connecting portion between the guide surface 76 and the flat surface of the bottom surface 51. That is, the first curved surface R21 is located at a position higher than the guide surface 76. Preferably, when viewed in a direction perpendicular to the bottom surface 51, the intersecting line of the first inclined surface 71 on the first side surface 52 side and the bottom surface 31, the intersecting line of the guide surface 76 and the bottom surface 31, and the intersecting line of the first inclined surface 71 on the second side surface 54 side and the bottom surface 31 are located on the same straight line. That is, the position of the above-described three intersecting lines is the position of the first boundary L21.

### Seventh Embodiment

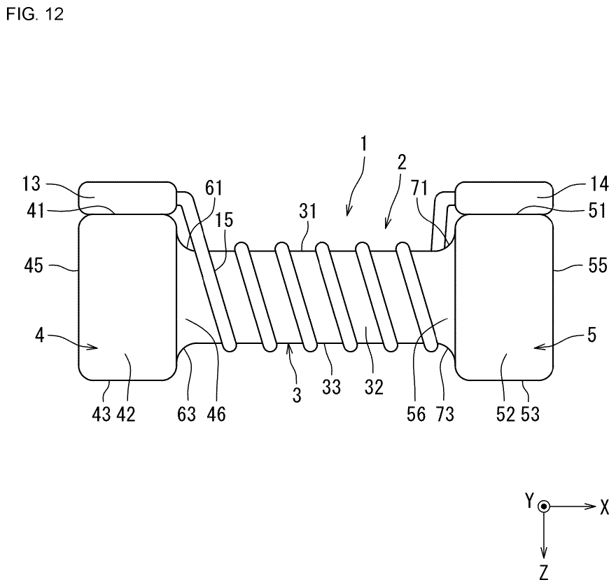

FIG. 12 is a side view of a coil component 1 according to a seventh embodiment of the present disclosure viewed from the first side surface 32 side of the winding core 3. The coil component 1 is a component in which a first terminal electrode 13, a second terminal electrode 14, and a wire 15 are added to the core 2 according to the first embodiment. The core 2 has the same configuration as the first embodiment, and the description thereof will be omitted.

As illustrated in FIG. 12, the coil component 1 has the core 2, the first terminal electrode 13 provided on the bottom surface 41 of the first flange 4, the second terminal electrode 14 provided on the bottom surface 51 of the second flange 5, and the wire 15 wound around the winding core 3. One end portion of the wire 15 is electrically connected to the first terminal electrode 13, and the other end portion of the wire 15 is electrically connected to the second terminal electrode 14. When the above-described configuration is adopted, the strength of the core 2 is improved, and the strength of the coil component 1 is also improved.

The first terminal electrode 13 and the second terminal electrode 14 are formed by, for example, applying a conductive paste containing conductive metal powder such as Ag powder, then baking the paste, and further performing Ni plating and Sn plating. Alternatively, the first terminal electrode 13 and the second terminal electrode 14 may be formed by, for example, pasting a conductive metal piece made of copper-based metal such as tough pitch copper or phosphor bronze to the first flange 4 and the second flange 5. The first terminal electrode 13 and the second terminal electrode 14 can be attached to the core 2 by, for example, providing a heater on or above the bottom surface 41 of the first flange 4 and the bottom surface 51 of the second flange 5, and thermocompression-bonding the first and the second terminal electrodes 13 and 14.

The wire 15 is a conductive wire with an insulating film in which a conductive wire made of, for example, metal such as copper, silver, or gold is covered with a film made of a resin such as polyurethane, polyester-imide, or polyamide-imide. The diameter of the wire 15 is not particularly limited, but is preferably within a range of 20 μm to 100 μm, for example. The wire 15 and each of the first terminal electrode 13 and the second terminal electrode 14 are connected by, for example, thermocompression-bonding, ultrasonic wave welding, laser welding, welding, or brazing. The number of times of winding of the wire 15 is not particularly limited. In addition, the wire 15 may be one wire, or a plurality of wires. When a plurality of wires 15 exists, the plurality of wires 15 may be simultaneously wound.

Note that the core 2 may be the core 2B according to the second embodiment, the core 2C according to the third embodiment, the core 2D according to the fourth embodiment, or the core 2F according to the sixth embodiment. When the core 2B according to the second embodiment, the core 2C according to the third embodiment, the core 2D according to the fourth embodiment, or the core 2F according to the sixth embodiment is used, the coil component 1 can be formed in the same manner as the seventh embodiment.

The core 2 may be the core 2E according to the fifth embodiment. The coil component 1 at this time includes four terminal electrodes. Specifically, a first terminal electrode is provided on the first bottom surface 41A. A second terminal electrode is provided on the second bottom surface 41B. A third terminal electrode is provided on the first bottom surface 51A. A fourth terminal electrode is provided on the second bottom surface 51B. A coil component 1 has two wires 15 wound around the core 2E and four terminal electrodes provided in the core 2E. That is, the coil component 1 is a common mode choke coil component. The first terminal electrode is provided on the first bottom surface 41A. The second terminal electrode is provided on the second bottom surface 41B. The third terminal electrode is provided on the first bottom surface 51A. The fourth terminal electrode is provided on the second bottom surface 51B. One wire 15 connects the first terminal electrode to the fourth terminal electrode. The other wire 15 connects the second terminal electrode to the third terminal electrode.

Note that the present disclosure is not limited to the above-described first to seventh embodiments, and various changes in design are conceivable without departing from the spirit of the present disclosure.

The present disclosure includes the following aspects.

<1> A core including a winding core; a first flange provided at a first end portion of the winding core; and a second flange provided at a second end portion of the winding core. The winding core has a first surface and a second surface located on opposite sides, and a first side surface and a second side surface intersecting the first surface and the second surface and located on opposite sides. The first flange has a first surface and a second surface located on opposite sides, a first side surface and a second side surface intersecting the first surface and the second surface and located on opposite sides, an inner-side end surface connected to the first end portion of the winding core, and an outer-side end surface located on an opposite side from the winding core. The inner-side end surface of the first flange has a first inclined surface located between the first surface of the winding core and the first surface of the first flange, and a second inclined surface located between the first side surface of the winding core and the first side surface of the first flange. A position of a first boundary where the first inclined surface intersects the first surface of the winding core is separated from a position of a second boundary where the second inclined surface intersects the first side surface of the winding core in a direction of an axis of the winding core.

<2> The core described in <1>, in which the position of the second boundary is closer to the second flange than is the position of the first boundary in the direction of the axis of the winding core.

<3> The core described in <1>, in which the position of the first boundary is closer to the second flange than is the position of the second boundary in the direction of the axis of the winding core.

<4> The core described in any one of <1> to <3>, in which the second inclined surface has a flat surface.

<5> The core described in any one of <1> to <4>, in which the second inclined surface has a recessed curved surface.

<6> The core described in any one of <1> to <5>, in which the second inclined surface has a projecting curved surface.

<7> The core described in any one of <1> to <6>, in which the inner-side end surface of the first flange further has a third inclined surface located between the second surface of the winding core and the second surface of the first flange. Also, a position of the third boundary where the third inclined surface intersects the second surface of the winding core is closer to the second flange than is the position of the first boundary in the direction of the axis of the winding core.

<8> The core described in any one of <1> to <7>, in which the axis of the winding core is closer to the second surface of the first flange than is a central line between the first surface and the second surface of the first flange when viewed from the first side surface.

<9> The core described in any one of <1> to <8>, in which the first surface of the first flange is divided into at least two.

<10> The core described in any one of <1> to <8>, in which the inner-side end surface of the first flange further has a flat guide surface existing in a direction from the first surface of the first flange toward the first surface of the winding core.

<11> A coil component including the core described in any one of <1> to <10>; a first terminal electrode provided on the first surface of the first flange; a second terminal electrode provided on the first surface of the second flange; and a wire wound around the winding core. One end portion of the wire is electrically connected to the first terminal electrode, and another end portion of the wire is electrically connected to the second terminal electrode.

What is claimed is:

1. A core comprising:
a winding core;
a first flange at a first end portion of the winding core; and
a second flange at a second end portion of the winding core, wherein
the winding core has a first surface and a second surface on opposite sides, and a first side surface and a second side surface intersecting the first surface and the second surface and on opposite sides,
the first flange has a first surface and a second surface on opposite sides, a first side surface and a second side surface intersecting the first surface and the second surface and on opposite sides, an inner-side end surface connected to the first end portion of the winding core, and an outer-side end surface on an opposite side from the winding core,
the inner-side end surface of the first flange has a first inclined surface between the first surface of the winding core and the first surface of the first flange, and a second inclined surface between the first side surface of the winding core and the first side surface of the first flange, and
a first boundary where the first inclined surface intersects the first surface of the winding core is separated from a second boundary where the second inclined surface intersects the first side surface of the winding core in a direction of an axis of the winding core.

2. The core according to claim 1, wherein
the second boundary is closer to the second flange than is the first boundary in the direction of the axis of the winding core.

3. The core according to claim 1, wherein
the first boundary is closer to the second flange than is the second boundary in the direction of the axis of the winding core.

4. The core according to claim 1, wherein
the second inclined surface has a flat surface.

5. The core according to claim 1, wherein
the second inclined surface has a recessed curved surface.

6. The core according to claim 1, wherein
the second inclined surface has a projecting curved surface.

7. The core according to claim 1, wherein
the inner-side end surface of the first flange further has a third inclined surface between the second surface of the winding core and the second surface of the first flange, and
a third boundary where the third inclined surface intersects the second surface of the winding core is closer to the second flange than is the first boundary in the direction of the axis of the winding core.

8. The core according to claim 1, wherein
the axis of the winding core is closer to the second surface of the first flange than is a central line between the first surface and the second surface of the first flange when viewed from the first side surface.

9. The core according to claim 1, wherein
the first surface of the first flange is divided into at least two.

10. The core according to claim 1, wherein
the inner-side end surface of the first flange further has a flat guide surface existing in a direction from the first surface of the first flange toward the first surface of the winding core.

11. A coil component comprising:
the core according to claim 1;
a first terminal electrode on the first surface of the first flange;
a second terminal electrode on the first surface of the second flange; and
a wire wound around the winding core, wherein
one end portion of the wire is electrically connected to the first terminal electrode, and
another end portion of the wire is electrically connected to the second terminal electrode.

12. The core according to claim 2, wherein
the second inclined surface has a flat surface.

13. The core according to claim 3, wherein
the second inclined surface has a flat surface.

14. The core according to claim 2, wherein
the second inclined surface has a recessed curved surface.

15. The core according to claim 3, wherein
the second inclined surface has a recessed curved surface.

16. The core according to claim 2, wherein
the second inclined surface has a projecting curved surface.

17. The core according to claim 2, wherein
the axis of the winding core is closer to the second surface of the first flange than is a central line between the first surface and the second surface of the first flange when viewed from the first side surface.

18. The core according to claim 2, wherein
the first surface of the first flange is divided into at least two.

19. The core according to claim 2, wherein
the inner-side end surface of the first flange further has a flat guide surface existing in a direction from the first surface of the first flange toward the first surface of the winding core.

20. A coil component comprising:
the core according to claim 2;
a first terminal electrode on the first surface of the first flange;
a second terminal electrode on the first surface of the second flange; and
a wire wound around the winding core, wherein
one end portion of the wire is electrically connected to the first terminal electrode, and
another end portion of the wire is electrically connected to the second terminal electrode.
